(19) United States
(12) Patent Application Publication
(10) Pub. No.: US 2024/0352599 A1
(43) Pub. Date: Oct. 24, 2024

(54) METAL FOAM POROUS TRANSPORT LAYERS AND POLYMER-ELECTROLYTE-MEMBRANE WATER ELECTROLYZERS WITH POROUS TRANSPORT LAYERS

(71) Applicant: Toyota Motor Engineering & Manufacturing North America, Inc., Plano, TX (US)

(72) Inventors: Gaohua Zhu, Ann Arbor, MI (US); Utsav Raj Aryal, Ypsilanti, MI (US); Bjorn Hasa, Ann Arbor, MI (US)

(73) Assignees: Toyota Motor Engineering & Manufacturing North America, Inc., Plano, TX (US); Toyota Jidosha Kabushiki Kaisha, Toyota-shi Aichi-ken (JP)

(21) Appl. No.: 18/234,920

(22) Filed: Aug. 17, 2023

Related U.S. Application Data
(60) Provisional application No. 63/460,951, filed on Apr. 21, 2023.

(51) Int. Cl. C25B 11/036; C25B 9/23; C25B 11/031; C25B 11/075; C25B 11/089

(52) U.S. Cl. CPC C25B 11/036; C25B 9/23; C25B 11/031; C25B 11/075; C25B 11/089

(57) ABSTRACT

A bipolar plate-porous transport layer (PTL) assembly for a polymer-electrolyte-membrane water electrolyzer includes a flat metallic bipolar plate and a metal foam PTL adjacent to and in direct contact with the flat metallic bipolar plate. The metal foam PTL includes flow channels defined by flow channels walls with flow channel surfaces. The flow channel walls and flow channel surfaces have an average porosity generally equal to an average porosity of an interior of the metal foam PTL.

### CROSS-REFERENCE TO RELATED APPLICATIONS

This application claims benefit of U.S. Provisional Application No. 63/460,951, filed on, Apr. 21, 2023, which is herein incorporated by reference in its entirety.

### TECHNICAL FIELD

The present disclosure generally relates to water electrolyzers, and particularly to polymer-electrolyte membrane water electrolyzers.

### BACKGROUND

Bipolar plates in polymer-electrolyte membrane water electrolyzer (PEMWE) cells function to remove oxygen produced by an oxygen evolution reaction (OER) at an anode side of the membrane and hydrogen produced by a hydrogen evolution reaction (HER) at a cathode side of the membrane. The product oxygen is present in the form of oxygen bubbles. A porous transport layer (PTL) may be located in the PEMWE between the membrane electrode assembly and the bipolar plate on the anode side. The PTL transports reactant water to an anode catalyst layer (CL) of the PEMWE. The PTL also function to assist in the removal of the oxygen bubbles produced by the anode side CL. The oxygen bubbles, when not removed in a timely manner, may coalesce into big bubbles in the PTL or in the bipolar plates. The big oxygen bubbles restrict reactant water from flowing to the anode CL, thereby creating an inactive surface area on the anode CL and reducing the overall performance of the PEMWE.

The present disclosure addresses the issue of oxygen bubble accumulation in the PTL or bipolar plates of a PEMWE, and other issues related to PEMWEs.

### SUMMARY

In one form of the present disclosure, a bipolar plate-porous transport layer (PTL) assembly for a PEMWE includes a flat metallic bipolar plate and a metal foam PTL adjacent to and in direct contact with the flat metallic bipolar plate. The metal foam PTL includes a planar section and a flow channel section with flow channels defined by flow channels walls with flow channel surfaces. Also, the flow channel walls and the flow channel surfaces have an average porosity generally that is equal to an average porosity of the planar section of the metal foam PTL.

In another form of the present disclosure, a PEMWE includes an anode, a membrane electrode assembly comprising a membrane, an anode catalyst layer, a cathode catalyst layer, and a metal foam PTL with a planar section and a flow channel section having flow channels defined by flow channels walls with flow channel surfaces. The PEMWE also includes a flat bipolar plate adjacent to and in direct contact with the metal foam PTL, and the flow channel walls and the flow channel surfaces have an average porosity generally that is equal to an average porosity of the planar section of the metal foam PTL.

These and other features of the bipolar plate-porous transport layer (PTL) assembly for a PEMWE will become apparent from the following detailed description when read in conjunction with the figures and examples, which are exemplary, not limiting.

### BRIEF DESCRIPTION OF THE DRAWINGS

The present teachings will become more fully understood from the detailed description and the accompanying drawings, wherein:

FIG. 1 illustrates a conventional PEMWE according to the prior art;

FIG. 2 illustrates a PEMWE with a metal foam porous transport layer (PTL) according to one form of the present disclosure;

FIG. 3 is a plot of normalized voltage versus normalized current density for a PEMWE1 with a metal foam PTL according to the teachings of the present disclosure;

FIG. 4A illustrates a metal foam used to form a metal foam PTL according to the teachings of the present disclosure;

FIG. 4B illustrates at least one step of forming flow channels in the metal foam in FIG. 4A;

FIG. 4C illustrates a metal foam PTL formed from the metal foam in FIG. 3 according to the teachings of the present disclosure; and

FIG. 5 is an optical microscopy image of a flow channel, flow channel walls, and flow channel surfaces of a metal foam PTL according to the teachings of the present disclosure.

It should be noted that the figures set forth herein is intended to exemplify the general characteristics of the methods, algorithms, and devices among those of the present technology, for the purpose of the description of certain aspects. The figure may not precisely reflect the characteristics of any given aspect and are not necessarily intended to define or limit specific forms or variations within the scope of this technology.

### DETAILED DESCRIPTION

The present disclosure provides a metal foam PTL and/or a PEMWE with one or more metal foam PTLs. The metal foam PTL includes flow channels defined by flow channel walls with flow channel surfaces, and the flow channels are formed in the metal foam PTL using a process such that an average porosity of the flow channel walls and flow channel wall surfaces is generally the same as an average porosity of an interior of the metal foam. Stated differently, and in contrast to cold pressing a metal foam to form flow channels therein, forming of the flow channels in the metal foam according to the teachings of the present disclosure does not compress the metal foam, does not result in a reduction of the porosity in the metal foam, and thereby provides a metal foam PTL for a PEMWE with enhanced oxygen bubble removal.

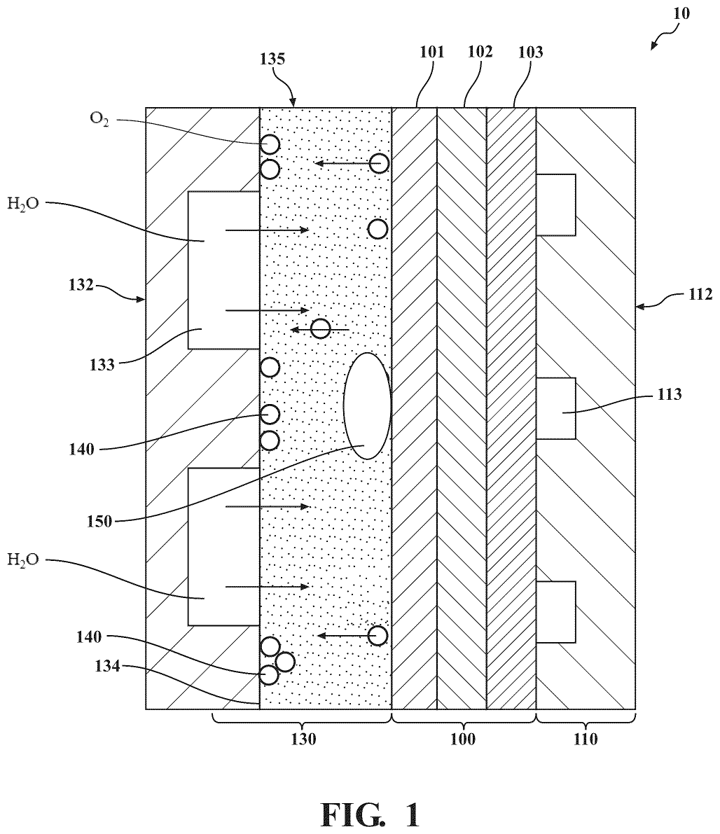

Referring now to FIG. 1, a conventional PEMWE 10 according to the prior art is shown. The PEMWE 10 includes a membrane electrode assembly (MEA) 100, a cathode side fluid flow system 110, and an anode side fluid flow system 130. The MEA 100 includes a polymer-electrolyte membrane 102 sandwiched between an anode 101 and a cathode 103. The cathode side fluid flow system 110 includes a conventional bipolar plate 112 with flow channels 113.

The anode side fluid flow system 130 includes a titanium bipolar plate 132 with flow channels 133 and ribbed portions 134. The anode side fluid flow system 130 further includes a PTL 135. The PTL 135 is, in one or more variations, comprised of platinum coated titanium mesh/foam/fibers. During operation of the PEMWE 10, water (H₂O) is provided to and flows through the PTL 135 to the anode 101 where H₂O is oxidized via an oxygen evolution reaction (OER) to oxygen (O₂), protons (H⁺) and electrons. In some variations, the O₂ is the in the form of O₂ bubbles 140. The O₂ bubbles 140 accumulate under the ribbed portions 134, creating an inactive portion 150 at the anode 101 by restricting the flow of H₂O to the inactive portion 150.

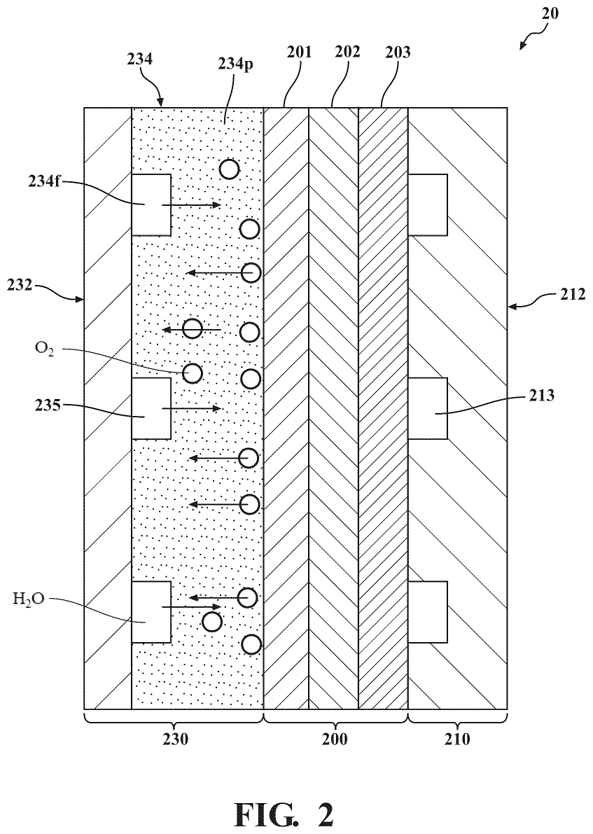

Referring now to FIG. 2, a PEMWE 20 with a metal foam PTL according to one form of the present disclosure is shown. The PEMWE 20 includes a membrane electrode assembly (MEA) 200, a cathode side fluid flow system 210, and an anode side fluid flow system 230. The MEA 200 includes a polymer-electrolyte membrane 202 sandwiched between an anode 201 and a cathode 203. The cathode side fluid flow system 210 includes a conventional bipolar plate 212 with flow channels 213.

The anode side fluid flow system 230 includes a flat bipolar plate 232 and a metal foam PTL 234 with a planar section 234p, a flow channel section 234f, and flow channels 235 within the flow channel section 234f. In some variations, the flow channels 235 are hollow flow channels, i.e., the flow channels 235 are not filled or occupied by a filler material and/or an adhesive. In addition, in some variations the flow channels are spaced apart from the anode 201 and are positioned proximal to the flat bipolar plate 232 as illustrated in FIG. 2.

During operation of the PEMWE 20, water (H₂O) is provided to and flows through the metal foam PTL 234 to the anode 201 where H₂O is oxidized via an oxygen evolution reaction (OER) to oxygen (O₂), protons (H⁺) and electrons. In some variations, the O₂ is the in the form of O₂ bubbles and the O₂ bubbles flow through the planar section 234p of the metal foam PTL 234 to the flow channels 235 and thereby transported out of the PEMWE 20. The H⁺ ions flow through the MEA 200 to the cathode side fluid flow system 210 to undergo a hydrogen evolution reaction (HER) at the cathode 203. In addition, and unlike conventional PEMWEs, such as the conventional PEMWE 10 of FIG. 1, flow or migration of the O₂ bubbles through the planar section 234p to the flow channels 235 decreases or reduces O₂ bubble accumulation at the anode 201 such that enhanced performance of the PEMWE 20 is provided.

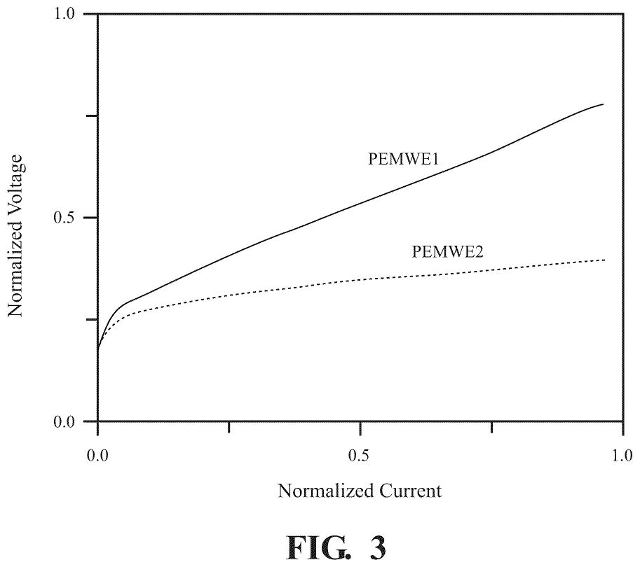

Referring to FIG. 3, a plot of normalized voltage versus normalized current density is shown for a conventional PEMWE (labeled as “PEMWE1) and PEMWE with a foam metal PTL with flow channels (labeled as “PEMWE2”) as discussed above in shown.

And as shown in FIG. 3, the PEMWE2 exhibits a decrease in normalized voltage as a function of normalized current compared to the PEMWE1.

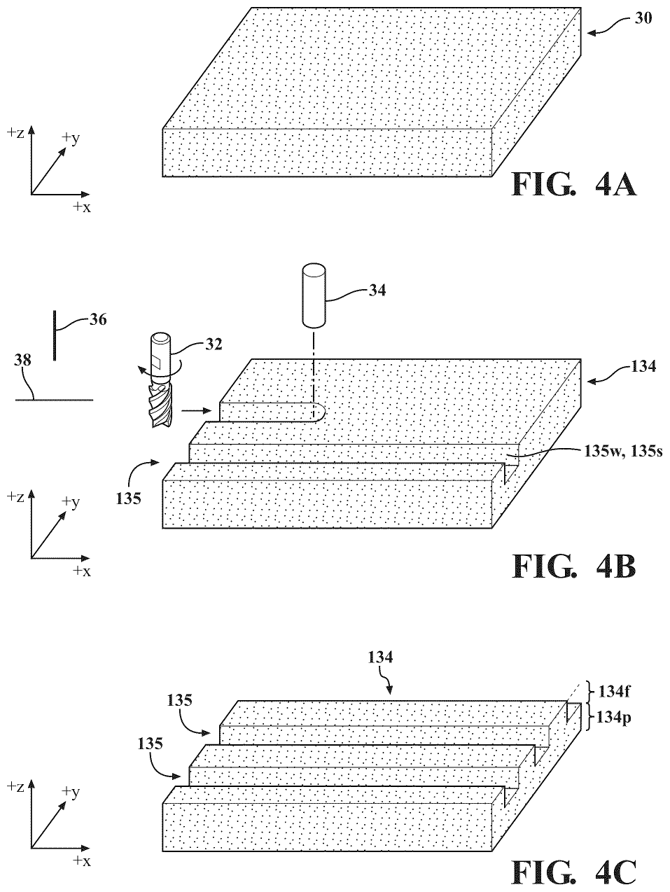

Referring now to FIGS. 4A-4C, steps for methods of forming or manufacturing the metal foam PTL 234 are shown. FIG. 4A illustrates a metal foam 40 having a predefined average porosity and/or a predefined average pore size is either purchased or formed using known porous metal (foam) manufacturing techniques. And in FIG. 4B, flow channels 235 defined by flow channel walls 235w and flow channels surfaces 235s are formed in the metal foam 40 such that the metal foam PTL 234 with the planar section 234p and flow channel section 234f is provided as shown in FIG. 34. Example methods or techniques for forming the flow channels 235 include CNC machining using a mechanical machining tool 42, laser machining using a laser 44, electrical discharge machining (EDM) using an EDM tool electrode 46, EDM machining using an EDM wire electrode 48, among others.

In some variations the average porosity of the metal foam 40 and the metal foam PTL 234 is between 50% and 90%, for example, between 65% and 85%, or between 70% and 80%. In at least one variation, the metal foam 30 and the metal foam PTL 234 have an average pore size between about 10 micrometers (μm) and about 100 μm, for example, between about 20 μm and about 75 μm, or between about 30 μm and about 50 μm. And in some variations, the surfaces of the metal foam PTL 234, i.e., the surfaces of the flow channels walls and the surfaces of the pores of the metal foam PTL 234 are hydrophilic. For example, in at least one variation, a contact angle between water droplets and the surfaces of the of the flow channels walls and the surfaces of the pores of the metal foam PTL 234 are less than about 90°, e.g., between about 600 and about 90°.

In some variations, a total thickness (z-direction in FIG. 3C) of the metal foam PTL 234 is between about 50 μm and 600 μm. And at least one variation, the flow channels 235 have a width (y-direction in FIG. 3C) between about 0.3 mm and about 1.5 mm. In some variations, the flow channels 235 have a depth (z-direction in FIG. 3C) between about 20 μm and about 300 μm.

Non-limiting examples of materials from which the metal foam 40 and the metal foam PTL 234 are formed include titanium, titanium alloy, iron, steel, stainless steel, nickel, a nickel alloy, aluminum, an aluminum alloy, copper, and a copper alloy.

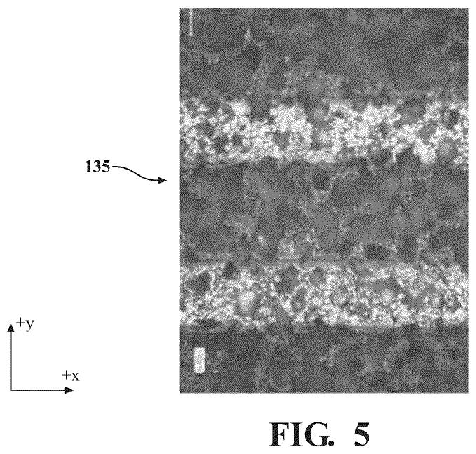

Referring to FIG. 5, an optical microscope image of a flow channel 235 defined by flow channels walls and flow channel surfaces is shown. And as observed in FIG. 5, the porosity and/or pore size has been maintained during forming of the flow channels.

The preceding description is merely illustrative in nature and is in no way intended to limit the disclosure, its application, or uses. As used herein, the phrase at least one of A, B, and C should be construed to mean a logical (A or B or C), using a non-exclusive logical “or.” It should be understood that the various steps within a method may be executed in different order without altering the principles of the present disclosure. Disclosure of ranges includes disclosure of all ranges and subdivided ranges within the entire range.

The headings (such as “Background” and “Summary”) and sub-headings used herein are intended only for general organization of topics within the present disclosure and are not intended to limit the disclosure of the technology or any aspect thereof. The recitation of multiple forms or variations having stated features is not intended to exclude other forms or variations having additional features, or other forms or variations incorporating different combinations of the stated features.

As used herein the term “about” when related to numerical values herein refers to known commercial and/or experimental measurement variations or tolerances for the referenced quantity. In some variations, such known commercial and/or experimental measurement tolerances are +/−10% of the measured value, while in other variations such known commercial and/or experimental measurement tolerances are +/−5% of the measured value, while in still other variations such known commercial and/or experimental measurement tolerances are +/−2.5% of the measured value. And in at least one variation, such known commercial and/or experimental measurement tolerances are +/−1% of the measured value.

As used herein, the terms “comprise” and “include” and their variants are intended to be non-limiting, such that recitation of items in succession or a list is not to the exclusion of other like items that may also be useful in the devices and methods of this technology. Similarly, the terms “can” and “may” and their variants are intended to be non-limiting, such that recitation that a form or variation can or may comprise certain elements or features does not exclude other forms or variations of the present technology that do not contain those elements or features.

The broad teachings of the present disclosure can be implemented in a variety of forms. Therefore, while this disclosure includes particular examples, the true scope of the disclosure should not be so limited since other modifications will become apparent to the skilled practitioner upon a study of the specification and the following claims. Reference herein to one aspect, or various aspects means that a particular feature, structure, or characteristic described in connection with a form or variation is included in at least one form or variation. The appearances of the phrase “in one variation” or “in one form” (or variations thereof) are not necessarily referring to the same form or variation. It should also be understood that the various method steps discussed herein do not have to be carried out in the same order as depicted, and not each method step is required in each form or variation.

The foregoing description of the forms or variations has been provided for purposes of illustration and description. It is not intended to be exhaustive or to limit the disclosure. Individual elements or features of a particular form or variation are generally not limited to that particular form or variation, but, where applicable, are interchangeable and can be used in a selected form or variation, even if not specifically shown or described. The same may also be varied in many ways. Such variations should not be regarded as a departure from the disclosure, and all such modifications are intended to be included within the scope of the disclosure.

While particular forms or variations have been described, alternatives, modifications, variations, improvements, and substantial equivalents that are or may be presently unforeseen may arise to applicants or others skilled in the art. Accordingly, the appended claims as filed and as they may be amended, are intended to embrace all such alternatives, modifications variations, improvements, and substantial equivalents.

What is claimed is:

1. A bipolar plate-porous transport layer (PTL) assembly for a polymer-electrolyte-membrane water electrolyzer (PEMWE), the bipolar plate-porous transport layer (PTL) assembly comprising:
a flat metallic bipolar plate; and
a metal foam PTL adjacent to and in direct contact with the flat metallic bipolar plate, the metal foam PTL comprising flow channels defined by flow channel walls and flow channel surfaces, wherein the flow channel walls and the flow channel surfaces have an average porosity generally equal to an average porosity of an interior of the metal foam PTL.

2. The bipolar plate-PTL assembly according to claim 1, wherein the flow channels are hollow flow channels.

3. The bipolar plate-PTL assembly according to claim 1, wherein the flow channel surfaces of the flow channel walls are hydrophilic with a contact angle between water droplets and the flow channel surfaces of the flow channel walls between about 600 and about 90°.

4. The bipolar plate-PTL assembly according to claim 1, wherein the metal foam PTL is formed from at least one of titanium, titanium alloy, iron, steel, stainless steel, nickel, a nickel alloy, aluminum, an aluminum alloy, copper, and a copper alloy.

5. The bipolar plate-PTL assembly according to claim 1, wherein the average porosity of the metal foam PTL is between about 65% and 85%.

6. The bipolar plate-PTL assembly according to claim 1, wherein the flow channels are laser machined flow channels.

7. The bipolar plate-PTL assembly according to claim 1, wherein the flow channels are CNC machined flow channels.

8. The bipolar plate-PTL assembly according to claim 1, wherein the flow channels are electrical discharge machined flow channels.

9. The bipolar plate-PTL assembly according to claim 1, wherein the metal foam PTL has a thickness between about 50 μm and 600 μm.

10. The bipolar plate-PTL assembly according to claim 9, wherein the flow channels have a width between about 0.3 mm and about 1.5 mm.

11. The bipolar plate-PTL assembly according to claim 10, wherein the flow channels have a depth between about 20 μm and about 300 μm.

12. A polymer-electrolyte-membrane water electrolyzer (PEMWE) comprising:
an anode;
a membrane electrode assembly comprising a membrane, an anode catalyst layer, and a cathode catalyst layer;
a metal foam porous transport layer (PTL) comprising an average porosity and flow channels defined by flow channel walls and flow channel surfaces; and
a flat bipolar plate adjacent to and in direct contact with the metal foam PTL, wherein the flow channel walls and the flow channel surfaces have an average porosity generally equal to the average porosity of the metal foam PTL.

13. The PEMWE according to claim 12, wherein the flow channels are hollow flow channels.

14. The PEMWE according to claim 12, wherein the flow channel surfaces of the flow channel walls are hydrophilic.

15. The PEMWE according to claim 12, wherein the metal foam PTL is formed from at least one of titanium, titanium alloy, iron, steel, stainless steel, nickel, a nickel alloy, aluminum, an aluminum alloy, copper, and a copper alloy.

16. The PEMWE according to claim 12, wherein the average porosity of the metal foam PTL is between about 65% and 85%.

17. The PEMWE according to claim 12, wherein the flow channels are at least one of: laser machined flow channels, CNC machined flow channels, and electrical discharge machined flow channels.

18. The PEMWE according to claim 12, wherein the metal foam PTL has a thickness between about 50 μm and 600 μm.

19. The PEMWE according to claim 12, wherein the flow channels have a width between about 0.3 mm and about 1.5 mm.

20. The PEMWE according to claim 19, wherein the flow channels have a depth between about 20 μm and about 300 μm.
